(19) United States
(12) Patent Application Publication
(10) Pub. No.: US 2010/0234542 A1
(43) Pub. Date: Sep. 16, 2010

(54) PREPARATION OF REACTIVE, ESSENTIALLY HALOGEN-FREE POLYISOBUTENES FROM C4-HYDROCARBON MIXTURES WHICH ARE LOW IN ISOBUTENE

(75) Inventors: J. Richard Blackborow, Strasbourg (FR); Hans Peter Rath, Gruenstadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/303,750

(22) PCT Filed: Jun. 5, 2007
(86) PCT No.: PCT/EP2007/055534

§ 371 Date: Dec. 8, 2008

(30) Foreign Application Priority Data
Jun. 6, 2006 (EP) 06114991.0

(51) Int. Cl. C08F 2/00

(52) U.S. Cl. 526/77

(57) ABSTRACT

The present invention relates to a process for preparing reactive and essentially halogen-free, especially fluorine-free, polyisobutenes from low-isobutene C₄ hydro-carbon mixtures.

The present invention relates to a process for preparing reactive and essentially halogen-free, especially fluorine-free, polyisobutenes from low-isobutene C₄ hydro-carbon mixtures.

High molecular weight polyisobutenes having molecular weights up to several 100 000 daltons have been known for some time; see, for example, H. Güterbock: Polyisobutylen and Mischpolymerisate [Polyisobutylene and copolymers], pages 77 to 104, Springer Verlag, Berlin 1959. The so-called reactive polyisobutenes are different from such conventional polyisobutenes. Reactive polyisobutenes differ from “low-reactivity polyisobutenes” by their higher content of terminal double bonds. In general, reactive polyisobutenes comprise at least 50 mol %, for example at least 60 mol %, of terminal double bonds, based on the total number of polyisobutene macromolecules. The terminal double bonds may be either 2-methyl-2-ene groups [—CH═C(CH₃)₂] (β-olefin) or vinylidene groups [—CH—C(═CH₂)—CH₃] (α-olefin). Such reactive polyisobutenes are used as intermediates for preparing additives for lubricants and fuels, as described, for example, in DE-A-2702604. The preparation of these additives comprises, for example, the formation of polyisobutene-maleic anhydride adducts or the alkylation, for example, of phenols. Mainly the terminal vinylidene groups react with maleic anhydride, whereas the double bonds further toward the interior of the macromolecules, depending on their position in the macromolecule, lead to a significantly lower conversion, if any, without the addition of halogens. The phenol alkylation, in contrast, is less critical with regard to the end groups, since the alkylation with polyisobutenes which are terminated with vinylidene groups proceeds via the same cationic intermediate as in the case of polyisobutenes terminated with 2-methyl-2-ene groups. The content of terminal double bonds in the polyisobutene molecule is therefore an important quality criterion of the reactive polyisobutenes. For use of reactive polyisobutenes as intermediates for preparing the aforementioned lubricant and fuel additives, a very uniform molecular weight distribution or dispersity is also required, since polyisobutenes with relatively broad molecular weight distribution are generally unusable for the purposes mentioned.

Reactive polyisobutenes are prepared typically by means of cationic polymerization of isobutene or isobutenic streams in the presence of suitable Lewis acids as a catalyst. Particularly suitable catalysts are boron trifluoride and boron trifluoride complexes. For reasons of cost, pure isobutene is not used in the polymerization reaction, but rather technical C₄ mixtures, i.e. mixtures of hydrocarbons having 4 carbon atoms (C₄ feedstocks) which, in addition to isobutene, comprise further C₄ hydrocarbons such as 1- and 2-butene, butane and isobutane. However, the isobutene concentrations of typical technical feedstocks are frequently in the range from 8 to 40% by weight of isobutene or even below 5% by weight of isobutene and thus significantly below the optimal concentration range. For example, for the preparation of polyisobutene having a mean molecular weight Mₙ of 1000, an isobutene concentration of from 60 to 65% by weight is desirable with a view to the achievement of high space-time yields and high isobutene conversions. Although it is known that the conversion of feedstocks having a suboptimal isobutene concentration can be increased when the reaction time is prolonged or the content of BF₃ in BF₃ complexes is increased, these measures are problematic owing to the organofluorine components formed. This is because the C—F bonds in the fluorinated polyisobutene molecules are labile, so that hydrogen fluoride is released in the further reaction of the polyisobutenes, for example with maleic anhydride or with phenols, which can lead to considerable corrosion problems. Moreover, the presence of HF in the combustion can promote the formation of (fluorinated) dioxins. It is also barely possible to remove the HF formed from the reaction products. A further problem is that many C₄ feedstocks comprise a not inconsiderable content of 1-butene. A relatively high content of 1-butene is problematic in that the polymer chain in the cationic polymerization of the isobutenic feedstock is preferably terminated at full isobutene conversions by copolymerized 1-butene. A polyisobutene molecule terminated with 1-butene has a great tendency to bind fluorine, for example from the boron trifluoride catalyst, so that the fluorine content of polyisobutenes from C₄ feedstocks having a relatively high content of 1-butene is significantly higher in comparison to polyisobutenes from C₄ feedstocks having a lower content of 1-butene. A high fluorine content of these polyisobutenes makes them, as already stated, unattractive for many applications, for example in the fuels sector, owing to the corrosive properties of HF or the formation of dioxins.

EP-A-0523838 describes a process for isomerizing linear olefins to isoolefins, for example of n-butenes to isobutene, in the presence of zeolites as isomerization catalysts.

U.S. Pat. No. 5,043,523 describes the isomerization of olefins, such as C₄ olefins, in the presence of low-sodium siloxane-modified γ-aluminum oxide as an isomerization catalyst.

DE 3118199 describes a process for isomerizing the C₄ constituent in C₃-C₄ hydro-carbon mixtures using fluorinated aluminum oxide in the presence of water or steam.

U.S. Pat. No. 4,436,949 describes the skeletal isomerization and disproportionation of olefins using acidic aluminum oxide as a catalyst in the presence of water.

EP 0192059 describes the dehydroisomerization of butane to isobutene using a zirconium oxide-supported chromium oxide/niobium pentoxide catalyst.

H. Güterbock describes, in “Polyisobutylen and Isobutylen-Mischpolymerisate”, Springer Verlag, 1959, the dehydroisomerization of butane to isobutene using aluminum oxide or aluminum silicates in porous form as catalysts. Also described is the isomerization of butenes to isobutene in the presence of various catalysts. This document also describes obtaining isobutene by depolymerizing isobutene oligomers.

EP-A-0671419 describes a process for preparing polyisobutene in which a C₄ hydrocarbon mixture is first subjected to a pretreatment to reduce the content of 1-butene and then the pretreated hydrocarbon mixture is polymerized.

U.S. Pat. No. 4,435,609 describes a process for hydroisomerizing 1-butene to 2-butenes using a metal of transition group VIII as a catalyst in the presence of hydrogen.

EP-A-0288362 describes a process in which butadiene present in a C₄ hydrocarbon mixture is hydrogenated and 1-butene is simultaneously isomerized to 2-butene. The reaction is effected in the presence of two different catalysts, the C₄ feedstock first passing through a hydrogenation catalyst (Pd in combination with Au and/or Pt, supported on aluminum oxide or silicon dioxide) to hydrogenate butadiene, and then an isomerization catalyst (Pd supported on aluminum oxide or silicon dioxide).

FR-A-2515171 describes the selective oligomerization of isobutene in a C₄ hydro-carbon mixture.

EP-A-0628575 and WO 99/64482 describe the preparation of reactive polyisobutenes by cationically polymerizing isobutene or isobutenic hydrocarbon streams in the presence of BF₃ in combination with alcohols or primary or secondary dialkyl ethers.

WO 97/06189 describes the preparation of halogen-free, reactive polyisobutenes by polymerizing isobutene or isobutenic hydrocarbon streams in the presence of a catalyst which, in addition to an oxygen-containing zirconium compound, comprises at least one oxygen-containing compound of at least one element from transition group I, II, III, IV, V, VII or VIII or from main group II, III, IV, V or VI, and does not comprise technically effective amounts of halogen.

It was an object of the present invention to provide a process for preparing reactive and essentially halogen-free, especially fluorine-free, polyisobutenes, which enables the use of low-isobutene and if appropriate 1-butene-rich C₄ hydrocarbon mixtures in an economically viable manner. Moreover, the process according to the invention should allow the preparation of polyisobutenes with a very narrow molecular weight distribution.

The object is achieved by a process for preparing reactive and essentially halogen-free polyisobutenes, comprising the following steps:
(i) isomerizing a mixture I of C₄ hydrocarbons which comprises at most 10% by weight of isobutene and at most 0.5% by weight of butadiene, based in each case on the total weight of the mixture I, to obtain a mixture Ia which comprises at least 5% by weight more isobutene than mixture I;
(ii) optionally hydroisomerizing at least a portion of the mixture Ia obtained in step (i) to obtain a mixture Ib which comprises at least 5% by weight less 1-butene than mixture Ia;
(iii) optionally obtaining essentially pure isobutene from at least a portion of the mixture Ia obtained in step (i) or from at least a portion of the mixture Ib obtained in step (ii);
(iv) optionally mixing
   (iv.1) the mixture Ia obtained in step (i) with the mixture Ib obtained in step (ii) or
   (iv.2) the mixture Ia obtained in step (i) with the isobutene obtained in step (iii) or
   (iv.3) the mixture Ib obtained in step (ii) with the isobutene obtained in step (iii) or
   (iv.4) the mixture Ia obtained in step (i) with the mixture Ib obtained in step (ii) and the isobutene obtained in step (iii) or
   (iv.5) the isobutene obtained in step (iii) with a mixture II of C₄ hydrocarbons other than mixtures Ia and Ib or
   (iv.6) the mixture Ib obtained in step (ii) with a mixture II of C₄ hydrocarbons other than mixtures Ia and Ib; and
(v) reacting the mixture Ia obtained in step (i) or the mixture Ib obtained in step (ii) or the mixture obtained in step (iv) or the isobutene obtained in step (iii) in a cationic polymerization in the presence of a BF₃-containing catalyst.

In the context of the present invention, reactive polyisobutenes are understood to mean polyisobutenes which comprise at least 60 mol %, preferably at least 70 mol %, more preferably at least 80 mol % and in particular at least 90 mol %, for example about 95 mol %, of terminal double bonds, based on the total number of polyisobutene macromolecules. The terminal double bonds may be either 2-methyl-2-ene groups [—CH═C(CH₃)₂] (β-olefin) or vinylidene groups [—CH—C(═CH₂)—CH₃] (α-olefin). However, they are preferably vinylidene groups.

In the context of the present invention, essentially halogen-free or fluorine-free means that the polyisobutene comprises at most 50 ppm, preferably at most 20 ppm, more preferably at most 15 ppm and in particular at most 10 ppm, for example at most 5 ppm or at most 2 ppm or at most 1 ppm of halogen, especially fluorine, based on the total weight of the polyisobutene. The ppm data are based here on ppm by weight, i.e. 1 ppm corresponds to 10⁻⁴% by weight.

According to the invention, a mixture I of C₄ hydrocarbons which has at most 10% by weight, based on the total weight of the mixture I, of isobutene is used in step (i). Mixture I preferably has at most 8% by weight and more preferably at most 5% by weight, based on the total weight of the mixture I, of isobutene.

Suitable mixtures I of C₄ hydrocarbons result, for example, if appropriate after one or more processing steps, in the hydrocarbon cleavage performed on the industrial scale in crude oil processing, for example by cracking such as fluid catalytic cracking (FCC), thermocracking, hydrocracking or dehydrogenation of isobutane. This affords, if appropriate after removal of higher- or lower-boiling hydrocarbons, technical olefin mixtures referred to as the C₄ cut. C₄ cuts are hydrocarbon mixtures whose main constituent is hydrocarbons having 4 carbon atoms, such as butane, isobutane, 1- and 2-butene and isobutene. C₄ cuts are obtainable, for example, by fluid catalytic cracking or steamcracking of gas oil, or by steamcracking of liquid gas or naphtha, or by dehydrogenating isobutane or field butane. Depending on the composition of the C₄ cut, a distinction is drawn between the total C₄ cut (crude C₄ cut), the so-called raffinate I obtained after the substantial removal of 1,3-butadiene, the raffinate II obtained after substantial removal of isobutene, or raffinate II P after additional removal of 1-butene, and the raffinate III obtained after further substantial removal of olefins. Typical compositions of the aforementioned C₄ raffinates can be found in the literature, for example in EP-A-0671419 or in Schulz, Homann, “Cₐ-Hydrocarbons and Derivatives, Resources, Production, Marketing”, Springer Verlag 1989.

In the case of raffinate II, the composition is different depending on whether the raffinate has been obtained in a steamcracker or an FC cracker, which processes were used to remove isobutene and which starting materials were used in the cracker.

For instance, raffinate II from steamcrackers with naphtha as the starting material and the removal of isobutene by etherification (for example to methyl tert-butyl ether) typically has essentially the following composition:

| | |
|---|---|
| isobutene: | in the range from 1 to 10% by weight, |
| | preferably in the range from 1.5 to 3% by weight, |
| 1-butene: | in the range from 40 to 60% by weight, |
| | preferably in the range from 45 to 55% by weight, |
| cis-2-butene: | in the range from 5 to 15% by weight, |
| | preferably in the range from 5 to 10% by weight, |
| trans-2- | in the range from 10 to 20% by weight, |
| butene: | preferably in the range from 12 to 18% by weight, |
| n-butane: | in the range from 10 to 20% by weight, |
| | preferably in the range from 12 to 20% by weight, |
| isobutane: | in the range from 5 to 10% by weight, or |
| | preferably in the range from 6 to 10% by weight. |

Raffinate II from FCC units depends to a greater extent upon the origin of the crude oil and, after the removal of isobutene by etherification, typically has essentially the following composition:

| | |
|---|---|
| isobutene: | in the range from 0.5 to 3% by weight, |
| | preferably in the range from 1 to 2% by weight, |
| 1-butene: | in the range from 15 to 25% by weight, |
| | preferably in the range from 17 to 24% by weight, |
| cis-2-butene: | in the range from 10 to 25% by weight, |
| | preferably in the range from 12 to 33% by weight, |
| trans-2- | in the range from 15 to 25% by weight, |
| butene: | preferably in the range from 17 to 23% by weight, |
| n-butane: | in the range from 10 to 20% by weight, |
| | preferably in the range from 10 to 17% by weight, |
| isobutane: | in the range from 20 to 35% by weight, |
| | preferably in the range from 22 to 33% by weight. |

Here and hereinafter, the expression “essentially” means that the content of further components in the compositions specified is at most 5% by weight, preferably at most 1% by weight, based on the total weight of the raffinate compositions. It is evident to the person skilled in the art that, when technical hydrocarbon mixtures are used, especially also fractions of hydrocarbons having less or more than 4 carbon atoms may be present as further components. In general, the content of further components in the raffinates or mixtures I of C₄ hydrocarbons used in the process according to the invention will not be more than 5% by weight based on the total weight.

A raffinate II P has typically essentially the following composition:

| | |
|---|---|
| isobutene: | in the range from 1 to 5% by weight, |
| | preferably in the range from 1.5 to 3% by weight, |
| 1-butene: | in the range from 1 to 5% by weight, |
| | preferably in the range from 2 to 4% by weight, |
| cis-2-butene: | in the range from 10 to 25% by weight, |
| | preferably in the range from 15 to 22% by weight, |
| trans-2- | in the range from 40 to 50% by weight, |
| butene: | preferably in the range from 42 to 48% by weight, |
| n-butane: | in the range from 25 to 40% by weight, |
| | preferably in the range from 28 to 38% by weight, |
| isobutane: | in the range from 10 to 20% by weight, |
| | preferably in the range from 12 to 18% by weight. |

A raffinate III has typically essentially the following composition:

| | |
|---|---|
| isobutene: | in the range from 0 to 3% by weight, |
| | preferably in the range from 0.1 to 1% by weight, |
| 1-butene: | in the range from 0 to 3% by weight, |
| | preferably in the range from 0.1 to 1% by weight, |
| cis-2-butene: | in the range from 1 to 5% by weight, |
| | preferably in the range from 1.5 to 3% by weight, |
| trans-2-butene: | in the range from 5 to 30% by weight, |
| | preferably in the range from 8 to 20% by weight, |
| n-butane: | in the range from 40 to 70% by weight, |
| | preferably in the range from 45 to 65% by weight, |
| isobutane: | in the range from 10 to 30% by weight, |
| | preferably in the range from 15 to 25% by weight. |

However, suitable mixtures I of C₄ hydrocarbons also arise from C₄ cuts which have been depleted in isobutene, for example by polymerization to polyisobutene. An example thereof is the content of this C₄ mixture remaining after the preparation of polyisobutene from raffinate I.

In step (i) of the process according to the invention, the mixture I used is preferably a raffinate II from a steamcracker or from an FCC unit, or a raffinate II P or a raffinate III from a steamcracker. The raffinates mentioned especially in each case have one of the above-specified compositions.

According to the invention, the mixture I used has a content of at most 0.5% by weight and preferably of at most 0.2% by weight, based on the total weight of the mixture I, of butadiene. Processes and treatment steps required if appropriate to reduce the content of butadiene, for example a selective hydrogenation, are known to the person skilled in the art and are described, for example, in EP-A-0288362 and the literature cited therein, which are hereby fully incorporated by reference.

In step (i) of the process according to the invention, an isomerization of at least a portion of the C₄ hydrocarbons present in the mixture I takes place. The isomerization is carried out under such conditions that the resulting mixture Ia comprises at least 5% by weight more isobutene than the mixture I used (i.e. when mixture I comprises x % by weight of isobutene, based on the total weight of the mixture I, the mixture Ia obtained in step (i) comprises at least (x+5) % by weight of isobutene based on the total weight of the mixture Ia). The mixture Ia preferably comprises at least 10% by weight, more preferably at least 15% by weight and in particular at least 20% by weight more isobutene than the mixture I used.

The content of isobutene in the mixture Ia obtained in step (i) is preferably at least 10% by weight, more preferably at least 15% by weight and in particular at least 20% by weight, based on the total weight of the mixture Ia.

The isomerization reaction in step (i) is preferably a dehydroisomerization or a skeletal isomerization. Of course, it is also possible for both isomerization types to proceed alongside one another under the given isomerization conditions. Moreover, dehydrogenations can also take place under the isomerization conditions of step (i), for example of isobutane to isobutene.

In the context of the present invention, skeletal isomerization is understood to mean a rearrangement reaction in which, in a formal sense, a methyl group migrates. An example thereof is the rearrangement of 2-butene to isobutene.

In the context of the present invention, a dehydroisomerization is understood to mean the dehydrogenation of an alkane to the corresponding alkene associated with a skeletal isomerization, the latter taking place before, simultaneously with or after the dehydrogenation. An example thereof is the dehydroisomerization of n-butane to isobutene.

These rearrangements are, also in order to increase the space-time yields, generally performed at comparatively high temperatures, generally in the range from 300 to 650° C. The isomerization in step (i) is preferably effected at a temperature in the range from 350 to 600° C.

To avoid excessive dehydrogenation, the dehydroisomerization preferably takes place in the presence of hydrogen. The skeletal isomerization takes place preferably in the presence of hydrogen and/or steam.

The isomerization can be carried out under reduced pressure, at ambient pressure or under elevated pressure. The term pressure here refers to the overall pressure which is composed of the pressure of the hydrocarbon mixture I and the pressure of any hydrogen and/or steam present. The isomerization is preferably effected under elevated pressure, preferably at a pressure of from 1.5 to 20 bar, in particular at from 2 to 10 bar.

The isomerization takes place preferably in the gas phase or above the critical temperature.

The isomerization in step (i) is effected generally in the presence of suitable catalysts.

Suitable catalysts for the skeletal isomerization are, for example, aluminum oxides, in particular γ-aluminum oxides, which preferably feature a low content of alkali metals and alkaline earth metals and which are siloxane-modified if appropriate, and also zeolites. Zeolites are ordered porous crystalline aluminosilicates having a defined structure and cavities connected via channels. Suitable catalysts are described, for example, in EP 523838, U.S. Pat. No. 5,043,523, U.S. Pat. No. 4,436,949 and DE 3118199 A1, which are hereby fully incorporated by reference.

Suitable catalysts for the dehydroisomerization are, for example, aluminum oxides, in particular γ-aluminum oxides, aluminosilicates in porous form (e.g bauxite, clay, kaolin), which are supported if appropriate and are activated with phosphoric acid, boric acid or hydrofluoric acid, and metal oxides of transition group metals, for example chromium oxide, niobium oxide and the like, the latter preferably being supported, for example on zirconium oxide. Suitable catalysts are described, for example, in EP 192059, U.S. Pat. No. 4,704,497, U.S. Pat. No. 4,806,624 and in EP 512911, which are hereby fully incorporated by reference.

Dehydroisomerizations are known in principle and are described, for example, in U.S. Pat. No. 4,806,624 and in particular in EP 512911, which are hereby fully incorporated by reference. Examples of catalysts which are suitable for the dehydroisomerization are, apart from in the two abovementioned documents, also described in EP 192059 and U.S. Pat. No. 4,704,497, which are hereby fully incorporated by reference.

Skeletal isomerizations too are known in principle and are described, for example, in EP 523838, U.S. Pat. No. 5,043,523, U.S. Pat. No. 4,436,949 and DE 3118199 A1, which are hereby fully incorporated by reference. Both details of the reaction conditions and of suitable catalysts can be found herein.

Whether the isomerization conditions in step (i) in accordance with the above-described conditions are selected more for a skeletal isomerization or more for a dehydroisomerization depends in particular upon the hydrocarbon mixture I used in step (i). When it is relatively rich in alkanes, if anything, conditions will be selected which promote a dehydroisomerization reaction, while one possibility in the case of mixtures I with a low content of alkanes is to select conditions which, if anything, promote a skeletal isomerization. On the other hand, the conditions which promote dehydroisomerizations and skeletal isomerizations do not differ so greatly from one another, so that generally both isomerization types proceed alongside one another.

If desired, the mixture Ia obtained in step (i) can be subjected to a hydroisomerization. In the context of the present invention, hydroisomerizations are understood to mean the rearrangement of olefinic double bonds, in which, in a formal sense, a hydrogen atom migrates. An example thereof is the double bond rearrangement in the isomerization of 1-butene to 2-butene.

The hydroisomerization affords, in step (ii), a mixture II whose content of 1-butene has been reduced by at least 20% by weight, preferably by at least 40% by weight, more preferably at least 60% by weight and in particular by at least 80% by weight, based on the 1-butene present in mixture Ia.

The mixture Ib obtained in step (ii) preferably comprises at most 10% by weight, more preferably at most 7% by weight, even more preferably at most 5% by weight and in particular at most 3% by weight, for example at most 2% by weight or at most 1% by weight of 1-butene, based on the total weight of the mixture Ib.

The hydroisomerization is performed at comparatively low temperatures, preferably at from 0 to 200° C., more preferably at from 20 to 100° C.

The hydroisomerization of step (ii) is also effected generally in the presence of hydrogen.

It preferably takes place under elevated pressure, for example at from 2 to 50 bar, preferably at from 5 to 30 bar. These pressure data relate to the total pressure of the reaction mixture which is composed of the partial pressure of the hydrocarbon mixture Ia used in step (ii) and the partial pressure of the hydrogen which is generally present.

The hydroisomerization conditions are suitably selected such that, on the one hand, essentially only any dienes (in particular butadiene) and alkynes (in particular acetylene and butynes) present are hydrogenated, and, on the other hand, 1-butene can isomerize to 2-butene.

The hydroisomerization is effected preferably in the presence of suitable catalysts. Suitable catalysts are, for example, transition metal catalysts such as palladium or platinum. The metal catalysts are preferably supported, for example on aluminum oxide, silicon dioxide or zirconium dioxide. Suitable catalysts are described, for example, in GB-A-2057006, which is hereby fully incorporated by reference. Some of the suitable catalysts, for example palladium on aluminum oxide, are commercially available (for example from Südchemie).

The procedure is preferably such that the mixture obtained in step (i) is transferred to a cooler reaction zone with a catalyst suitable for the hydroisomerization, in which case this reaction zone may be arranged in the same reactor as the reaction zone for the isomerization reaction of step (i) or in another reactor.

The hydroisomerization in step (ii) rearranges, in particular, 1-butene to 2-butene. Accordingly, step (ii) is performed in particular when polyisobutenes with low halogen content, especially fluorine content, are to be obtained and the content of 1-butene in mixture Ia from step (i) is relatively large, for example at least 5% by weight or even at least 10% by weight. The content of 1-butene in mixture Ia is large in particular when the mixture I used is a hydrocarbon stream which has a relatively high content of 1-butene, for example at least 5% by weight or at least 10% by weight, as is the case, for example, for raffinate II, and/or when the content of 1-butene in mixture Ia, owing to the isomerization reaction of step (i), increases in comparison to mixture I, for example to at least 5% by weight or at least 10% by weight, for example because the isomerization conditions, especially higher temperatures, also promote the formation of 1-butene.

Accordingly, step (ii) is preferably carried out when a mixture I which comprises at least 5% by weight of 1-butene is used in step (i), for example a mixture other than raffinate II P or raffinate III, such as raffinate II, and/or when a mixture Ia which comprises at least 5% by weight of 1-butene is obtained in step (i).

On the other hand, it is possible to dispense with step (ii) in spite of a relatively high content of 1-butene in the mixture Ia obtained in step (i) when the optional step (iii) is performed, in which essentially pure isobutene is obtained and is used in the polymerization reaction of step (v) or is mixed with a lower-isobutene mixture in step (iv), for example with the mixture Ia obtained in step (i), which not only increases the isobutene content in this lower-isobutene mixture but simultaneously lowers the 1-butene content, and this mixture is then subjected to the polymerization.

Suitable hydroisomerization reactions are known in principle and are described, for example, in EP-A-671419, U.S. Pat. No. 4,435,609, and EP-A-0288362 and in particular in GB-A-2057006 which are hereby fully incorporated by way of reference.

In the context of the present invention “essentially pure isobutene” which is optionally obtained in step (iii) is understood to mean an isobutenic mixture which comprises at least 75% by weight, preferably at least 85% by weight, more preferably at least 95% by weight of isobutene, based on the total weight of the isobutenic mixture. Of course, the isobutenic mixture may also be pure isobutene, i.e. at least 99% isobutene.

In a preferred embodiment of step (iii), essentially pure isobutene is obtained by a distillation of mixture Ia or of mixture Ib.

Suitable distillation apparatus and distillation conditions are known to those skilled in the art and are described, for example, in FR 2528033, which is hereby fully incorporated by reference.

Owing to the similar boiling points of isobutene and 1-butene (−6.8° C. and −6.7° C. respectively), this separation variant is, however, suitable in particular for those mixtures Ia and Ib which do not comprise a high content of 1-butene, for example at most 10% by weight of or at most 5% by weight of 1-butene. However, it is entirely possible also to perform this separation variant with 1-butene-richer mixtures when the mixture of the isobutene obtained from this separation variant is then effected in step (iv) so as to obtain mixtures II with sufficiently low 1-butene contents, for example by mixing this relatively 1-butene-rich isobutene with a 1-butene-depleted mixture Ib.

In an alternatively preferred embodiment of step (iii), obtaining essentially pure isobutene comprises the following steps:
(iii.a) selectively oligomerizing the isobutene contained in mixture Ia or in mixture Ib to obtain isobutene oligomers;
(iii.b) distillatively removing the volatile constituents from the isobutene oligomers; and
(iii.c) cleaving the isobutene oligomers into isobutene monomers.

The selective oligomerization of isobutene in raffinate streams is known in principle and is described, for example, in FR 2515171 which is hereby fully incorporated by reference. Volatile constituents are removed from the isobutene oligomers by means of distillation in the customary manner known to those skilled in the art. It is possible to obtain essentially pure isobutene from the isobutene oligomers by dissociation. The depolymerization of isobutene oligomers is known in principle and is described, for example, in H. Güterbock, Polyisobutylen and Isobutylen-Mischpolymerisate, Springer Verlag, 1959, pages 23-26, which is hereby fully incorporated by reference. For instance, to obtain essentially pure isobutene from dimeric, trimeric and higher oligomers of isobutene, temperatures in the range from 200 to 450° C. and the presence of modified aluminum trioxide or silicon dioxide are suitable.

In an alternatively preferred embodiment of step (iii), obtaining essentially pure isobutene comprises the following steps:
(iii.a) selectively etherifying the isobutene contained in mixture Ia or in mixture Ib with an aliphatic C₁-C₆-alcohol to obtain a tert-butyl ether of the aliphatic C₁-C₆-alcohol;
(iii.b) distillatively removing the volatile constituents from the tert-butyl ether of the aliphatic C₁-C₆-alcohol; and
(iii.c) cleaving the tert-butyl ether of the aliphatic C₁-C₆-alcohol to isobutene monomers and the aliphatic C₁-C₆-alcohol.

Suitable alcohols are, for example, methanol, ethanol, n-propanol, isopropanol, n-butanol, sec-butanol, isobutanol (2-methylpropan-1-ol), n-pentanol, 2- and 3-pentanol, neopentanol, n-hexanol and positional isomers thereof. Preferred alcohols are primary alcohols such as methanol, ethanol, n-propanol, n-butanol, isobutanol, n-pentanol and n-hexanol. Particular preference is given to using methanol or isobutanol, even greater preference being given to isobutanol (2-methylpropan-1-ol).

The selective etherification of isobutene present in mixture Ia or Ib is effected by customary etherification processes, as described, for example, in Ullmann's Encyclopedia of Industrial Chemistry, 5th edition on CD-ROM, Wiley-VCH, chapter “Methyl tert-butyl ether”, chapter 4 “Production” and chapter “Butenes”, chapter 5 “Upgrading of butene”, which is hereby fully incorporated by reference. Volatile constituents are removed from the tert-butyl ethers formed here by means of distillation in the customary manner known to those skilled in the art. The tert-butyl ethers can be dissociated to isobutene monomers and the alcohol used. This is generally effected by customary processes for cleaving ethers, as described, for example, in Ullmann's Encyclopedia of Industrial Chemistry, 5th edition on CD-ROM, Wiley-VCH, chapter “Methyl tert-butyl ether”, chapter 4 “Production” and chapter “Butenes”, chapter 5 “Upgrading of butene”, or in U.S. Pat. No. 4,287,379, which are hereby fully incorporated by reference.

The optional mixing step (iv) serves to optimize isobutenic mixtures with regard to their composition, especially their isobutene and 1-butene content, for the polymerization. This can prevent an entire suboptimal C₄ hydrocarbon stream from having to be subjected to process steps (i) and, if required, (ii) and/or (iii) before the polymerization.

For example, the mixture Ia obtained in step (i) can only partly be subjected to step (ii) and then the resulting mixture Ib can be mixed with the fraction of Ia not converted in step (ii).

In addition, the mixture Ia obtained in step (i) or the mixture Ib obtained in step (ii) or both can be mixed with the essentially pure isobutene obtained in step (iii), for example when the amount of isobutene present in the mixtures Ia and/or Ib is not sufficiently high and/or when the 1-butene content present in one of the components (in particular in mixture Ia or else in the isobutene) is too high.

Moreover, the essentially pure isobutene obtained in step (iii) or the mixture Ib obtained in step (ii) can be mixed with C₄ hydrocarbon streams (mixture II) other than mixture Ia or Ib. Suitable mixtures II are, for example, the mixture I used in step (i), raffinate 1 or C₄ cuts from FCC units. Preferred mixtures II are raffinate I and C₄ cuts from FCC units.

The composition of the raffinate I depends upon whether the feedstock used was liquefied gas, naphtha or mixtures thereof, naphtha leading to a raffinate I with higher isobutene contents.

The raffinate I obtained from steamcrackers has essentially the following composition:

| | |
|---|---|
| isobutene: | in the range from 35 to 55% by weight, |
| | preferably in the range from 35 to 48% by weight, |
| 1-butene: | in the range from 25 to 35% by weight, |
| | preferably in the range from 27 to 33% by weight, |
| cis-2-butene: | in the range from 2 to 10% by weight, |
| | preferably in the range from 3 to 8% by weight, |
| trans-2-butene: | in the range from 5 to 15% by weight, |
| | preferably in the range from 6 to 13% by weight, |
| n-butane: | in the range from 5 to 15% by weight, |
| | preferably in the range from 7 to 13% by weight, |
| isobutane: | in the range from 2 to 10% by weight, |
| | preferably in the range from 3 to 8% by weight. |

The C₄ cut obtained from FCC units essentially has the following composition:

| | |
|---|---|
| isobutene: | in the range from 10 to 20% by weight, |
| | preferably in the range from 12 to 18% by weight, |
| 1-butene: | in the range from 10 to 20% by weight, |
| | preferably in the range from 12 to 20% by weight, |
| cis-2-butene: | in the range from 10 to 20% by weight, |
| | preferably in the range from 12 to 18% by weight, |
| trans-2-butene: | in the range from 10 to 25% by weight, |
| | preferably in the range from 12 to 22% by weight, |
| n-butane: | in the range from 5 to 15% by weight, |
| | preferably in the range from 7 to 13% by weight, |
| isobutane: | in the range from 15 to 25% by weight, |
| | preferably in the range from 7 to 23% by weight. |

The increase in the content of isobutene in low-isobutene mixtures of C₄ hydrocarbons in step (iv) of the process according to the invention increases the availability of isobutene which can be fed to a polymerization to prepare reactive polyisobutenes. This enables in particular those embodiments of the process according to the invention which allow economically viable utilization of C₄ streams for preparing reactive polyisobutenes without any need to isolate the isobutene from the entire amount of the C₄ streams used. For this purpose, for example, the isobutene is obtained in substantially pure form from a portion of the C₄ hydrocarbons used as mixture I after isomerization. This is done as described above by the removal of the isobutene from the mixture Ia or Ib (step (iii)). The isobutene monomers thus obtained in essentially pure form can be used to enrich available C₄ hydrocarbon mixtures. In this way, it is possible to establish optimal isobutene concentrations in the reaction mixtures provided for polymerization in a simple manner. For instance, the pure isobutene removed as described above can be blended directly with isobutene-rich C₄ hydrocarbon mixtures such as raffinate I or FCC—C₄ cuts. C₄ raffinate streams which have comparatively low contents of isobutene of, for example, less than 10% by weight are likewise suitable for blending with the isobutene monomers obtained as described above when their content of isobutene has been increased by means of the above-described isomerization (for example mixture Ia or Ib).

The individual mixture components which are used in step (iv) may be of the same or different origin.

In a preferred embodiment, essentially pure isobutene (from step (iii)) is mixed in step (iv) with a mixture Ia (from step (i)) and/or a mixture Ib (from step (ii)). In this case, mixture Ia, mixture Ib and the essentially pure isobutene may stem from the same mixture or from different mixtures I of C₄ hydrocarbons.

In an alternatively preferred embodiment, essentially pure isobutene (from step (iii)) is mixed in step (iv) with a relatively isobutene-rich C₄ cut, for example with raffinate I.

To perform the process according to the invention, it has been found to be particularly advantageous to adjust the mixing ratio in step (iv) such that the resulting mixture has a content of isobutene of preferably at least 30% by weight, more preferably at least 40% by weight, in particular at least 50% by weight and especially at least 60% by weight, based in each case on the total weight of the mixture obtained in step (iv). It is also preferred to adjust the mixing ratio such that the resulting mixture has a content of 1-butene of preferably at most 10% by weight, more preferably at most 5% by weight, in particular at most 2% by weight and especially at most 1% by weight, based in each case on the total weight of the mixture obtained in step (iv).

The conversion of isobutene to reactive polyisobutenes in the presence of boron trifluoride or boron trifluoride complexes as catalysts is known and is described, for example, in EP-A-1095070 (WO 99/64482), EP-A-0628575 and EP-A-0671419, which are hereby fully incorporated by reference.

The catalyst used is boron trifluoride, frequently in combination with a suitable donor (cocatalyst; complexing agent). Suitable cocatalysts are alcohols, carboxylic acids, aldehydes, ketones, nitriles, phenols and dialkyl ethers. The Lewis acceptor-donor complex which forms (also) has BrØnsted acid properties in the case of use of protic donors such as alcohols or carboxylic acids. Particularly suitable complexes have both Lewis acid and BrØnsted acid properties.

The polymerization is effected generally at a temperature of from −100° C. to 100° C., preferably from −60° C. to 40° C. and more preferably from −40° C. to 20° C.

Further suitable reaction conditions are described in EP-A-1095070 (WO 99/64482), EP-A-0628575 and EP-A-0671419, which are hereby fully incorporated by reference.

In a preferred embodiment of the process, the components obtained in step (iii), from which the essentially pure isobutene is removed, and/or the components obtained after the polymerization in step (v), from which the polyisobutene formed has been removed, are recycled back into step (i). The components obtained in step (iii) are, for the most part, C₄ hydrocarbons other than isobutene. The components obtained in step (v) are, for the most part, unpolymerized C₄ hydrocarbons (isobutene and other C₄ hydro-carbons) and/or isobutene oligomers. Particular preference is given to recycling when these components obtained in step (iii) or (v) have a low content of 1-butene, for example at most 5% by weight or at most 2% by weight, based on the total weight of the components, so that they do not have to be used in step (ii).

In a preferred embodiment, the process according to the invention comprises step (i) and step (v), i.e. steps (i) and (v) are obligatory, while steps (ii), (iii) and (iv) are optional.

In an alternatively preferred embodiment, the process according to the invention comprises step (i), step (ii), if appropriate step (iii), if appropriate step (iv) and step (v), i.e. steps (i), (ii) and (v) are obligatory, while steps (iii) and (iv) are optional.

In an alternatively preferred embodiment, the process according to the invention comprises step (i), if appropriate step (ii), step (iii), if appropriate step (iv) and step (v), i.e. steps (i), (iii) and (v) are obligatory, while steps (ii) and (iv) are optional.

In an alternatively preferred embodiment, the process according to the invention comprises step (i), if appropriate step (ii), step (iii), step (iv) and step (v), i.e. steps (i), (iii), (iv) and (v) are obligatory, while step (ii) is optional.

In an alternatively preferred embodiment, the process according to the invention comprises step (i), step (ii), step (iii), if appropriate step (iv) and step (v), i.e. steps (i), (ii), (iii) and (v) are obligatory, while step (iv) is optional.

In an alternatively preferred embodiment, the process according to the invention comprises step (i), step (ii), step (iii), step (iv) and step (v), i.e. all 5 steps (i), (ii), (iii), (iv) and (v) are obligatory.

The remarks made above on preferred embodiments of the individual process steps apply here both individually taken alone and in combination.

The polyisobutenes prepared by the process according to the invention have a number-average molecular weight Mₙ of preferably from 100 to 10 000, more preferably from 500 to 5000 and in particular from 800 to 3000, for example about 1000 or about 1500 or about 2000 or about 2500.

In addition, the polyisobutenes prepared by the process according to the invention have a polydispersity (PDI=M_{w}/Mₙ; M_{w}=weight-average molecular weight) of preferably at most 3, for example from 1 to 3, more preferably of at most 2.5, for example from 1 to 2.5, even more preferably of at most 2, for example from 1 to 2, and in particular of at most 1.8, for example from 1 to 1.8 or from 1.2 to 1.8.

The values specified for Mₙ and M_{w} are based on values determined by gel permeation chromatography (GPC) using polyisobutene standards.

The polyisobutenes prepared by the process according to the invention preferably have at least 60 mol %, more preferably at least 70 mol %, even more preferably at least 80 mol % and in particular at least 90 mol %, for example about 95 mol %, of terminal double bonds, based on the total number of polyisobutene macromolecules. The terminal double bonds are vinylidene groups (α-double bond) or 2-methyl-2-ene groups (β-double bonds). The terminal double bonds are preferably vinylidene groups (α-double bond); i.e. the polyisobutenes prepared by the process according to the invention preferably have at least 60 mol %, more preferably at least 70 mol %, even more preferably at least 80 mol % and in particular at least 90 mol %, for example about 95 mol %, of terminal vinylidene double bonds, based on the total number of polyisobutene macromolecules.

The content of terminal double bonds is determined by means of ¹H NMR spectroscopy.

In particular, the polyisobutenes prepared by the process according to the invention are notable in that they are essentially halogen-free, especially essentially fluorine-free. Halogens such as fluorine may be present in particular in the form of organofluorine compounds. For use of the reactive polyisobutenes prepared for the preparation of lubricant and fuel additives, it is generally sufficient when the content of fluorine in the reactive polyisobutenes is at most 0.005% by weight. The halogen content and especially the fluorine content in the polyisobutenes prepared in accordance with the invention is preferably at most 0.005% by weight, more preferably at most 0.002% by weight, even more preferably at most 0.0015% by weight, even more preferably at most 0.001% by weight, for example at most 5×10⁻⁴% by weight or at most 2×10⁻⁴% by weight, and in particular at most 1×10⁻⁴% by weight, based on the total weight of the polyisobutenes.

The fluorine content is determined by means of customary processes, for example by combustion analysis with subsequent wet analysis.

The experimental examples which follow illustrate some aspects and embodiments of the present invention. They should in no way be interpreted as restrictive.

### EXAMPLES

The Mₙ and M_{w} values were determined by means of GPC (polyisobutene standards). The content of terminal vinylidene groups was determined by means of ¹H NMR. The fluorine content was determined by means of wet and combustion analysis.

### Example 1

A stream of a raffinate III of the following composition:

| | |
|---|---|
| 1-butene: | 0.3% by weight |
| cis-2-butene: | 1.9% by weight |
| trans-2-butene: | 4.2% by weight |
| isobutene: | 0.0% by weight |
| n-butane: | 78.5% by weight |
| isobutane: | 15.1% by weight |

was fed to a dehydroisomerization zone together with 100 ppm of water. The catalyst used here was a zirconium-based catalyst which was prepared according to EP-A-192059, example 1b), except that the niobium content was 0.1 mol per mole of ZrO₂ and no chromium oxide was used. After calcining at 650° C. for two hours, the catalyst was obtained as a powder with 40×60 mesh and a surface area of 40 m²/g. The dehydroisomerization zone was operated at an absolute hydrogen pressure of 5 bar at 560° C. The weight hourly space velocity was 5 kg of reaction mixture per hour and kg of catalyst. After one hour, gas samples were taken and analyzed. The conversion of butanes to butenes was 58%, the selectivity 96%. The isobutene content was 33% and the 1-butene content 13%. This reactor discharge was fed to a second isomerization zone of lower temperature. In the second isomerization zone, an aluminum oxide catalyst (95% aluminum oxide, 5% SiO₂, Siral®5, Degussa, converted to paste with formic acid, strand-granulated and calcined at 350° C. for 2 h; strand diameter 2 mm, strand length 2-6 mm, surface area 342 m²/g) was used. The second isomerization zone was operated at 70° C. with a flow rate of 1 kg of reaction mixture per hour and per kg of catalyst. The discharge of C₄ hydrocarbons from the second isomerization zone had a content of isobutene of 39% by weight and a content of 1-butene of 5% by weight, based in each case on the total weight of the discharge.

The polymerization was performed analogously to EP-A-628575, example 1. On the suction side of a loop reactor equipped with a circulation pump integrated therein (tube diameter 10 mm; volume 100 ml), 600 g of the discharge from the second isomerization zone was fed in over the course of one hour to perform the polymerization reaction. This formed a catalyst composed of a BF₃-2-butanol complex in situ (22 mmol of BF₃; 37 mmol of 2-butanol). The reactor was cooled such that the internal temperature was −13° C. The isobutene conversion was 60%, the mean residence time 6.6 minutes. To stop the polymerization, the reaction discharge was admixed continuously with 100 ml/h of 10% aqueous NaOH in a stirred vessel, and the residual liquefied gas was evaporated at 40° C. For further purification, the degassed product was dissolved in hexane and extracted three times with water. After the solvent had been removed and distillative oligomers removal at 3 mbar and 220° C., the residue obtained was a polymer having a mean molecular weight Mₙ=2207 and a polydispersity M_{w}/Mₙ=1.8. The polymer had a fluorine content of 9 ppm.

### Example 2

A stream of a raffinate IIa of the following composition:

| | |
|---|---|
| 1-butene | 52.3% by weight |
| cis-2-butene | 8.1% by weight |
| trans-2-butene | 14% by weight |
| isobutene | 1.8% by weight |
| n-butane | 16.6% by weight |
| isobutane | 7.2% by weight |

was fed to a skeletal isomerization zone together with 100 ppm of water. In this example, an aluminum oxide catalyst (95% aluminum oxide, 5% SiO₂, Siral®5, Degussa, slurried in water, admixed with 0.2% aqueous Na₂CO₃ solution, filtered off, dried overnight at 100° C., strand-granulated and calcined at 350° C.; strand diameter 2 mm, strand length 2-6 mm, surface area 327 m²/g) was used. The skeletal isomerization was operated at an absolute hydrogen pressure of 5 bar and a temperature of 425° C. The weight hourly space velocity was 2 kg of reaction mixture per hour and per kg of catalyst. The discharge from the skeletal isomerization zone had a content of isobutene of 22% by weight and a content of 1-butene of 12% by weight, based in each case on the total weight of the discharge.

The discharge from the skeletal isomerization zone was fed to a reactor to perform an etherification reaction. In the reactor, the reaction mixture was reacted with sec-butyl alcohol. The mixture obtained in this way was subjected to a fractional distillation. In this way, a fraction of pure sec-butyl tert-butyl ether was obtained. This fraction was dissociated back to sec-butyl alcohol and isobutene in a separate cracking reaction. The isobutene obtained in this reaction had a purity of 99% by weight.

The isobutene obtained in this way was used to prepare reactive polyisobutene. The reactor used was a circulation reactor consisting of a 7.1 m-long Teflon tube with an internal diameter or 6 mm, through which 100 l/h of reactor contents were conducted in circulation with a gear pump. Tube and pump had a capacity of 200 ml. Teflon tube and pump head were disposed in a cold bath cooled to −23.8° C. by means of a cryostat. A mixture of 300 g/h of isobutene and 300 g/h of hexane was dried to <3 ppm of water by means of a 3 A molecular sieve, precooled to 23.8° C. and fed to the reactor through a capillary with internal diameter 2 mm. BF₃ and isopropanol/diisopropyl ether as complexing agents were fed into the hexane feed. The BF₃ feed was adjusted to 23.5 mmol and the total amount of the feed of the mixture of hexane, isopropanol and diisopropyl ether was adjusted so as to attain an isobutene conversion of 92%. The reactor discharge was worked up analogously to example 1. A polymer with a mean molecular weight Mₙ=1110 and a polydispersity M_{w}/Mₙ=1.6 was obtained. The polymer had a content of terminal vinylidene groups of 95%. The content of fluorine in the polymer was less than 1 ppm.

### Example 3

A stream of raffinate II P of the following composition:

| | |
|---|---|
| 1-butene | 4.1% by weight |
| cis-2-butene | 16.2% by weight |
| trans-2-butene | 28.1% by weight |
| isobutene | 3.4% by weight |
| n-butane | 33.6% by weight |
| isobutane | 14.6% by weight |

was fed to a dehydroisomerization zone together with 100 ppm of water. In the dehydroisomerization zone, a zirconium-based catalyst according to example 1 was used. The dehydroisomerization zone was operated at 565° C. and 5 bar absolute of hydrogen pressure. The weight hourly space velocity was 5 kg of reaction mixture per hour and per kg of catalyst. The discharge from the dehydroisomerization zone comprised 18% by weight of isobutene and 12% by weight of 1-butene. This discharge was contacted with an acidic fixed bed catalyst according to example 1 of EP 843688 at 10° C. The resulting discharge was subjected to a fractional distillation. A bottoms fraction was obtained which comprised oligomers of isobutene and especially dimers, trimers and tetramers of isobutene. This bottoms fraction was converted to essentially pure isobutene by means of cracking at 280° C. over an aluminum/AlF₃-based catalyst (fluorine content 7.8%).

The isobutene thus obtained was used analogously to example 2 to prepare reactive polyisobutene. A polymer having a mean molecular weight Mₙ=1090 and a polydispersity M_{w}/Mₙ=1.6 was obtained. The polymer had a content of terminal vinylidene groups of 95 mol %. The fluorine content in the resulting polymer was less than 1 ppm.

### Examples 4 to 7

The reaction mixture used for examples 4 to 7 to polymerize isobutene monomers was obtained in each case by blending or enriching different C₄ streams with essentially pure isobutene. The added isobutene was obtained as described in example 3.

The raffinate used for blending in example 4 is a raffinate I from the C₄ fraction of a steamcracker operated predominantly with naphtha of the following composition:

| | |
|---|---|
| 1-butene | 29.0% by weight |
| cis-2-butene | 4.5% by weight |
| trans-2-butene | 7.7% by weight |
| isobutene | 45.4% by weight |
| n-butane | 9.3% by weight |
| isobutane | 4.1% by weight |

In example 5, a C₄ stream from the catalytic cracker of a refinery of the following composition was used for blending:

| | |
|---|---|
| 1-butene | 12.0% by weight |
| cis-2-butene | 10.9% by weight |
| trans-2-butene | 23.2% by weight |
| isobutene | 16.3% by weight |
| n-butane | 15.8% by weight |
| isobutane | 21.8% by weight |

In example 6, a raffinate II P of a steamcracker of the following composition:

| | |
|---|---|
| 1-butene | 4.1% by weight |
| cis-2-butene | 16.2% by weight |
| trans-2-butene | 28.1% by weight |
| isobutene | 3.4% by weight |
| n-butane | 33.6% by weight |
| isobutane | 14.6% by weight |

which had been subjected to a dehydroisomerization reaction according to example 3 was used for blending.

In example 7, a raffinate III of the following composition:

| | |
|---|---|
| 1-butene | 0.3% by weight |
| cis-2-butene | 1.9% by weight |
| trans-2-butene | 4.2% by weight |
| isobutene | 0.0% by weight |
| n-butane | 78.5% by weight |
| isobutane | 15.10% by weight |

which had been subjected to a dehydroisomerization reaction according to example 1 was used for blending.

In all examples 4 to 7, the blending was undertaken such that the reaction mixture provided for the polymerization had an isobutene content of 60% by weight based on the total weight of the reaction mixture. The polymerization of isobutene was performed analogously to example 2. In the polymerization, a flow rate of 600 g/h of reaction mixture, 70 mmol of BF₃/h, 40 mmol/h of isopropanol and 80 mmol/h of diisopropyl ether was established.

The table below shows, for the polymer obtained in each case, the mean molecular weight Mₙ, the polydispersity PDI=M_{w}/Mₙ and the reactivity in %, i.e. the content of terminal vinylidene groups.

| Example | Mₙ | PDI | Reactivity [%] |
|---|---|---|---|
| 4 | 1090 | 1.6 | 93 |
| 5 | 1075 | 1.6 | 92 |
| 6 | 1105 | 1.6 | 95 |
| 7 | 1095 | 1.6 | 94 |

1. A process for preparing reactive and essentially halogen-free polyisobutenes, comprising:
(i) isomerizing a mixture (I) of C₄ hydrocarbons which comprises at most 10% by weight of isobutene and at most 0.5% by weight of butadiene, based in each case on the total weight of the mixture (I), at a temperature in the range from 300 to 650° C. to obtain a mixture {Ia) which comprises at least 5% by weight more isobutene than mixture (I), wherein the isomerization in step (i) comprises a dehydroisomerization or skeletal isomerization of at least a portion of the C₄ hydrocarbons present in mixture (I);
(ii) optionally hydroisomerizing at least a portion of the mixture (Ia) obtained in step (i) to obtain a mixture (Ib) which comprises at least 5% by weight less 1-butene than mixture (Ia);
(iii) obtaining essentially pure isobutene from at least a portion of the mixture (Ia) obtained in step (i) or from at least a portion of the mixture (Ib) obtained in step (ii);
(iv) optionally mixing
(iv.1) the mixture (Ia) obtained in step (i) with the mixture (Ib) obtained in step (ii) or
(iv.2) the mixture (Ia) obtained in step (i) with the isobutene obtained in step (iii) or
(iv.3) the mixture (Ib) obtained in step (ii) with the isobutene obtained in step (iii) or
(iv.4) the mixture (Ia) obtained in step (i) with the mixture (Ib) obtained in step (ii) and the isobutene obtained in step (iii) or
(iv.5) the isobutene obtained in step (iii) with a mixture II of C₄ hydrocarbons other than mixtures (Ia) and (Ib) or
(iv.6) the mixture Ib obtained in step (ii) with a mixture II of C₄ hydrocarbons other than mixtures Ia and Ib; and
(v) reacting the mixture (Ia) obtained in step (i) or the mixture (Ib) obtained in step (ii) or the mixture obtained in step (iv) or the isobutene obtained in step (iii) in a cationic polymerization in the presence of a BF₃-containing catalyst.

2. The process according to claim 1, comprising:
(i) isomerizing a mixture (I) of C₄ hydrocarbons which comprises at most 10% by weight of isobutene and at most 0.5% by weight of butadiene, based in each case on the total weight of the mixture (I), at a temperature in the range from 300 to 650° C. to obtain a mixture (Ia) which comprises at least 5% by weight more isobutene than mixture (I), wherein the isomerization in step (i) comprises a dehydroisomerization or skeletal isomerization of at least a portion of the C₄ hydrocarbons present in mixture (I);
(ii) hydroisomerizing at least a portion of the mixture (Ia) obtained in step (i) to obtain a mixture (Ib) which comprises at least 5% by weight less 1-butene than mixture (Ia);
(iii) obtaining essentially pure isobutene from at least a portion of the mixture (Ia) obtained in step (i) or from at least a portion of the mixture (Ib) obtained in step (ii);
(iv) optionally mixing
(iv.1) the mixture (Ia) obtained in step (i) with the mixture (Ib) obtained in step (ii) or
(iv.2) the mixture (Ia) obtained in step (i) with the isobutene obtained in step (iii) or
(iv.3) the mixture (Ib) obtained in step (ii) with the isobutene obtained in step (iii) or
(iv.4) the mixture (Ia) obtained in step (i) with the mixture Ib obtained in step (ii) and the isobutene obtained in step (iii) or
(iv.5) the isobutene obtained in step (iii) with a mixture (II) of C₄ hydrocarbons other than mixtures (Ia) and (Ib) or
(iv.6) the mixture (Ib) obtained in step (ii) with a mixture (II) of C₄ hydrocarbons other than mixtures (Ia) and (Ib); and
(v) reacting the mixture (Ia) obtained in step (i) or the mixture (Ib) obtained in step (ii) or the mixture obtained in step (iv) or the isobutene obtained in step (iii) in a cationic polymerization in the presence of a BF₃-containing catalyst.

3. The process according to claim 1, wherein the mixture (I) used in step (i) comprises at most 5% by weight of isobutene.

4. The process according to claim 1, wherein the mixture (Ia) obtained in step (i) comprises at least 10% by weight more isobutene than mixture (I).

5. The process according to claim 1, wherein essentially pure isobutene is obtained in step (iii) by distilling the mixture (Ia) or the mixture (Ib).

6. The process according to claim 1,
wherein obtaining essentially pure isobutene comprises the following steps:
(iii.a) selectively oligomerizing the isobutene contained in mixture (Ia) or in mixture (Ib) to obtain isobutene oligomers;
(iii.b) distillatively removing the volatile constituents from the isobutene oligomers; and
(iii.c) cleaving the isobutene oligomers into isobutene monomers.

7. The process according to claim 1, wherein essentially pure isobutene is obtained by:
(iii.a) selectively etherifying the isobutene contained in mixture (Ia) or in mixture (Ib) with an aliphatic C₁-C₆-alcohol to obtain a tert-butyl ether of the aliphatic C₁-C₆-alcohol;
(iii.b) distillatively removing the volatile constituents from the tert-butyl ether of the aliphatic C₁-C₆-alcohol; and
(iii.c) cleaving the tert-butyl ether of the aliphatic C₁-C₆-alcohol to isobutene monomers and the aliphatic C₁-C₆-alcohol.

8. The process according to claim 7, wherein the aliphatic C₁-C₆-alcohol is selected from the group consisting of methanol and 2-methyl-1-propanol.

9. The process according to claim 1, wherein the mixture (I) used is a raffinate (II) from a steamcracker and/or from a fluid catalytic cracking unit and/or a raffinate (II P) from a steamcracker and/or a raffinate (III) from a steamcracker.

10. The process according to claim 9, wherein
the raffinate (II) has essentially one of the following compositions:

| | |
|---|---|
| a) isobutene: | in the range from 1 to 10% by weight, |
| 1-butene: | in the range from 40 to 60% by weight, |
| cis-2-butene: | in the range from 5 to 15% by weight, |
| trans-2-butene: | in the range from 10 to 20% by weight, |
| n-butane: | in the range from 10 to 20% by weight, |
| isobutane: | in the range from 5 to 10% by weight, or |
| b) isobutene: | in the range from 0.5 to 3% by weight, |
| 1-butene: | in the range from 15 to 25% by weight, |
| cis-2-butene: | in the range from 10 to 25% by weight, |
| trans-2-butene: | in the range from 15 to 25% by weight, |
| n-butane: | in the range from 10 to 20% by weight, |
| isobutane: | in the range from 20 to 35% by weight, and |

the raffinate (II P) has essentially the following composition:

| | |
|---|---|
| isobutene: | in the range from 1 to 5% by weight, |
| 1-butene: | in the range from 1 to 5% by weight, |
| cis-2-butene: | in the range from 10 to 25% by weight, |
| trans-2-butene: | in the range from 40 to 50% by weight, |
| n-butane: | in the range from 25 to 40% by weight, |
| isobutane: | in the range from 10 to 20% by weight, and |

the raffinate (III) has essentially the following composition:

| | |
|---|---|
| isobutene: | in the range from 0 to 3% by weight, |
| 1-butene: | in the range from 0 to 3% by weight, |
| cis-2-butene: | in the range from 1 to 5% by weight, |
| trans-2-butene: | in the range from 5 to 30% by weight, |
| n-butane: | in the range from 40 to 70% by weight, |
| isobutane: | in the range from 10 to 30% by weight. |

11. The process according to claim 1, wherein the mixture (II) used is a raffinate (I) obtained from a steamcracker or a C₄ cut from a fluid catalytic cracking unit of a refinery.

12. The process according to claim 11, wherein the raffinate (II) or the C₄ cut has essentially one of the following compositions:

| | |
|---|---|
| a) isobutene: | in the range from 35 to 55% by weight, |
| 1-butene: | in the range from 25 to 35% by weight, |
| cis-2-butene: | in the range from 2 to 10% by weight, |
| trans-2-butene: | in the range from 5 to 15% by weight, |
| n-butane: | in the range from 5 to 15% by weight, |
| isobutane: | in the range from 2 to 10% by weight, or |
| b) isobutene: | in the range from 10 to 20% by weight, |
| 1-butene: | in the range from 10 to 20% by weight, |
| cis-2-butene: | in the range from 10 to 20% by weight, |
| trans-2-butene: | in the range from 10 to 25% by weight, |
| n-butane: | in the range from 5 to 15% by weight, |
| isobutane: | in the range from 15 to 25% by weight. |

13. The process according to claim 1, wherein the mixing ratio of the components of the mixture components is adjusted in step (iv) such that the mixture obtained in step (iv) has a content of isobutene of at least 30% by weight based on the total weight of the resulting mixture.

14. The process according to claim 1, wherein polyisobutenes having a content of fluorine of less than 0.005% by weight based on the weight of the polyisobutene molecule are obtained.
